(19) United States
(12) Patent Application Publication
(10) Pub. No.: US 2005/0207753 A1
(43) Pub. Date: Sep. 22, 2005

(54) Optical protection apparatus

(75) Inventor: Eisaku Touma, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 10/931,030

(22) Filed: Sep. 1, 2004

(30) Foreign Application Priority Data
Mar. 17, 2004 (JP) 2004-077203

(51) Int. Cl. G02F 1/00

(52) U.S. Cl. 398/32

(57) ABSTRACT

An optical protection apparatus has a unit for correctly determining which system is being used, a foreground system or a background system. Optical signals of WDM device reception units 13-1 and 13-2 are input to an optical SW 33 of an SW unit 14. At this time, pilot light having a wavelength band different from that of a main signal is inserted to the optical signal of the background system. On the output side of the optical SW 33, the presence/absence of pilot light is determined. Thus, if pilot light has come to the output side, a background system is selected. If it has not come to the output side, the foreground system is selected.

### BACKGROUND OF THE INVENTION

1. Field of the Invention

The present invention relates to a wavelength division multiplexing (WDM) apparatus, and more specifically to an optical protection apparatus in the WDM apparatus.

2. Description of the Related Art

The wavelength division multiplexing (WDM) is a system for multiplexing an optical signal having different wavelengths into one optical fiber and transmitting the signal. Recently, there has been a system realized for optical wavelength multiplexing 100 wavelengths or more at a transmission speed of 10 Gbps.

Normally, in a communications circuit, a signal path (a transmission line, a transmission device, an intra-device configuration package) has redundancy. In the conventional network including a wavelength division multiplexing system, there often is a redundant system configured by an electric process in a time division multiplexing (TDM) device, etc. connected under the wavelength multiplexing apparatus. However, with a higher multiplexing level of a wavelength multiplexing apparatus, there has been a strong demand of configuring a redundant system of a signal at an optical signal level.

FIG. 1 is an explanatory view of a conventional wavelength multiplexing system.

In FIG. 1, at the transmission terminal, an optical signal transmitted by a TDM device 10 provided for each wavelength is divided into two by an optical coupler 11, the divided signals are transmitted by inputting to WDM device transmission units 12-1 and 12-2 and received on the reception side as two systems, and the output of one of the received two systems is selected by an optical switch 14, and transmitted to a lower TDM device 15, which is a received terminal switching configuration. In FIG. 1, a TXP refers to a transmission transponder for converting a normal optical signal input from a lower device into an optical signal having a wavelength appropriate for an ITU-T grid, etc. for use in wavelength multiplexing. The optical signals λ1 through λ8 converted by the transmission transponder are wavelength multiplexed by the WDM MUX, then amplified by the transmission light amplifiers in the WDM device transmission units 12-1 and 12-2 into a level appropriate for optical transmission, and transmitted to transmission lines #1 and #2. The reduced optical levels of optical signals which have passed through the transmission lines #1 and #2 are compensated for by the reception light amplifiers in the WDM device reception units 13-1 and 13-2, and then wavelength demultiplexed by the WDM DMUX into the optical signals λ1 through λ8. The wavelength demultiplexed signals are transmitted to an RXP (reception transponder). The RXP is a transponder having an OE (optoelectrical converter) resistant to the noise of the ASE (naturally emitted light) being output by an optical amplifier, and an input optical signal is converted into a signal having an optical output prescribed wavelength such as normal STM−x (x=1 through 64) and prescribed power, and then transmitted.

FIG. 2 shows in detail a reception side including an SW unit for performing optical reception terminal switching by the prior art shown in FIG. 1.

RXPs 20-1 and 20-2 perform detection of input disconnection (LOL: loss of light), detection of displaced frame (LOF: loss of frame), and monitor of error performance (BER: bit error rate, SD: signal degradation). For example, assume that the system 0 is a foreground system, the system 1 is a background system, and the system 0 is selected for a SW. In the initial status, both systems 0 and 1 are free of the LOL, LOF, or error status in the RXPs 20-1 and 20-2 and the SW unit 14. From this status, if a switch trigger (the LOL, LOF, and exceeding an error threshold in the RXP, and the LOL in the SW unit 14) occurs in the foreground system, then a control unit 21 of the SW unit 14 which receives the information switches the SW selection to the background system on condition that there is no warning status (LOL, LOF, exceeding an error threshold, and LOL of the SW unit 14) in the background system. The system 1 which is a background system is switched on, the optical output of the SW unit 14 is the optical output of the system 1, the passage of a signal to a lower device is recovered after a switch trigger is detected and the SW control is delayed.

In FIG. 2, an IN Mon refers to a monitor for the LOL, and an OH Mon refers to a monitor for detecting error information about an overhead. In the RXPs 20-1 and 20-2, the LOL is monitored as an optical signal, and then the optical signal is converted into an electric signal by a opto-electric converter 22. When the signal is converted into an electric signal, the frame of the signal can be detected. Therefore, the overhead of the frame can be checked and the LOF, error performance, etc. can be detected. Afterwards, the electric signal is converted by an electrooptic converter 23 into an optical signal, and is then transmitted.

The prior art is disclosed by the patent literature 1 and 2. In the patent literature 1, the technology of superposing a monitor control signal on the main signal and then transmitting the resultant signal is disclosed. In the patent literature 2, an optical path switch monitor system using monitor light is disclosed.
[patent literature 1] Japanese Patent Application Laid-open No. Hei 8-186559
[patent literature 2] Japanese Patent Application Laid-open No. Hei 11-237651

In the system described above by referring to the conventional technology, an optical switch element is used as a signal switch unit. The system for the switch element can be a system of mechanically switching an optical path, a system for switching an optical path using an opto-magnetic effect (Kerr effect, etc.), etc. These switches have no monitoring function for generally confirming the operation status through feedback. Therefore, when the switches are used in switching an optical signal, the status to be controlled (what control signal is input) can be checked, but a selected system cannot be detected. In a transmission system having a redundant system, it is essential to confirm the currently selected system in the operation of transferring a fault of a transmission line. However, from the above-mentioned characteristic of the optical SW, the final selection of the system cannot be confirmed, thereby causing a serious problem in operating a network.

FIGS. 3 and 4 are explanatory views showing the conventional problems.

As shown in FIG. 3, if there arises a fault of the optical SW, and a control signal for selection of the system 0 is input, but the system 1 is actually output, then a fault transfer operation is performed on the system 1. In this case, an unexpected circuit disconnection can be made. Furthermore, in the case other than a fault transfer, if the system which is not currently selected in the apparatus has a disconnection due to an abnormal transmission line, a device fault, etc., then a switching operation cannot work because the system selected by the apparatus is not output, thereby failing in normally operating the protection by the optical switch, and causing a circuit disconnection.

### SUMMARY OF THE INVENTION

The present invention aims at providing a device for correctly determining which is actually used, the foreground system or the background system, in the optical protection apparatus.

The optical protection apparatus according to the present invention enables correct communications even though there occurs a fault by switching between an optical signal of a foreground system and a background system, and includes: a switch unit for receiving an optical signal of a foreground system and an optical signal of a background system, and selecting the optical signal of the foreground system or the optical signal of the background system; a pilot signal multiplexing unit for multiplexing a pilot light having a wavelength different from those of the optical signal of the foreground system and the optical signal of the background system with the optical signal of the foreground system or the optical signal of the background system; and a pilot light detection unit for detecting on the output side of the switch unit whether or not a pilot light is contained in the optical signal output by the switch unit on the output side of the switch unit.

According to the present invention, even if the switch unit becomes faulty and does not operate according to the input control signal, it is correctly determined which system is actually used, the foreground system or the background system.

### BRIEF DESCRIPTION OF THE DRAWINGS

FIG. 1 is an explanatory view of a conventional wavelength multiplexing system;

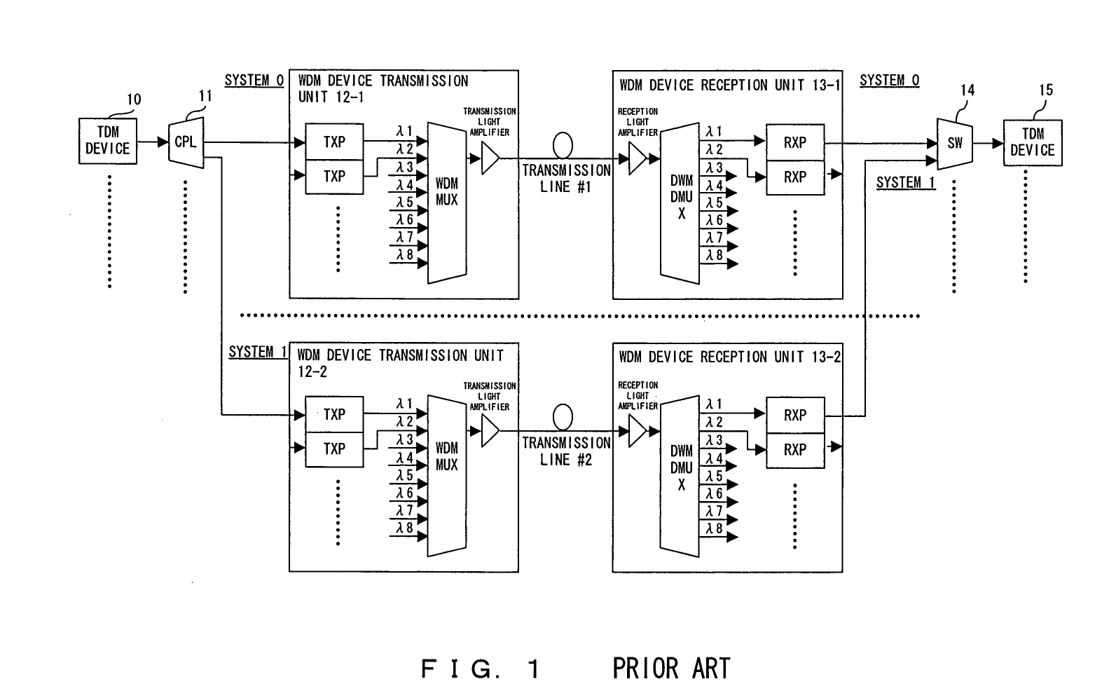

FIG. 2 shows in detail the reception side including the SW unit for an optical reception terminal switch according to the conventional technology shown in FIG. 1;

FIG. 3 is an explanatory view (1) showing the problem with the conventional technology;

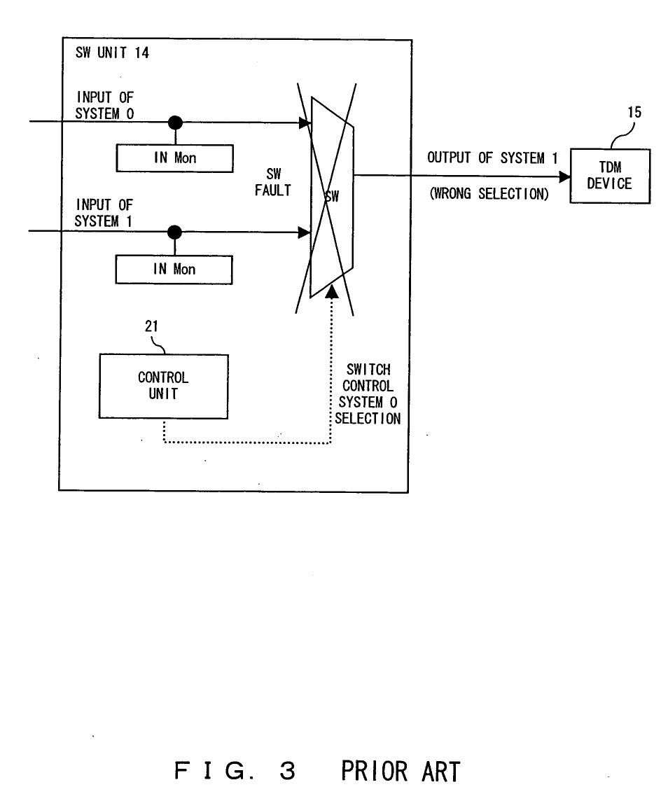

FIG. 4 is an explanatory view (2) showing the problem with the conventional technology;

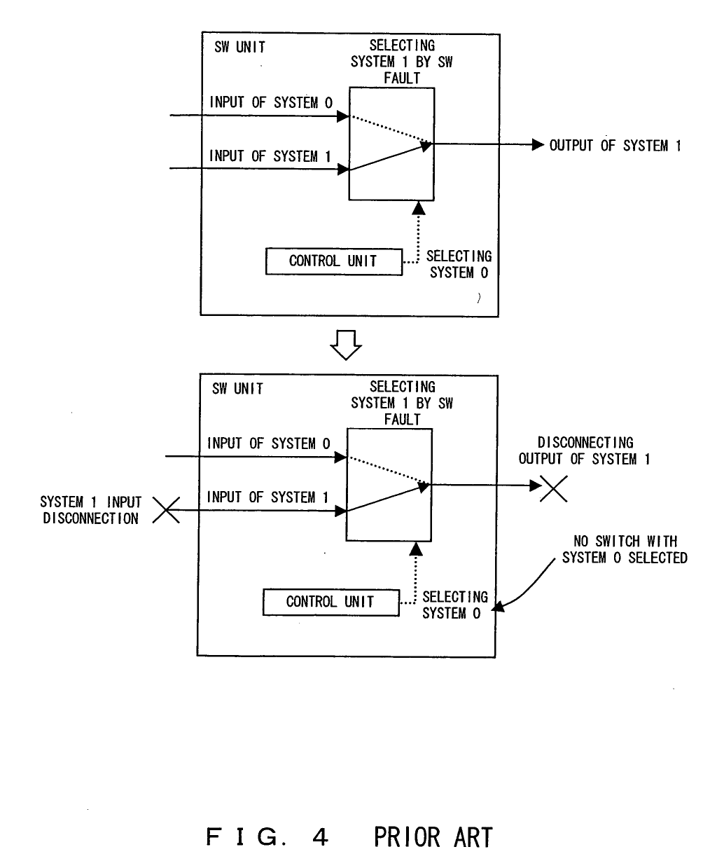

FIG. 5 shows the first embodiment of the present invention;

FIG. 6 shows the characteristic of the WDM coupler shown in FIG. 5

FIG. 7 is an explanatory view (1) of the second embodiment of the present invention; and

FIG. 8 is an explanatory view (2) of the second embodiment of the present invention.

### DESCRIPTION OF THE PREFERRED EMBODIMENTS

The following methods are used in the embodiment of the present invention.

(1) On the input side of the optical SW, either the system 0 or one of the system 1 of the main signal output from the RXP (reception transponder) is multiplexed with a wavelength light different from the main signal as a pilot light, and input to the optical SW.

(2) On the input side of the optical SW, the main signal is demultiplexed from the pilot light, and it is detected whether or not the pilot light has passed through the optical SW.

(3) Depending on the current selection system and the presence/absence of the pilot light after passing through the optical SW, the final system selection in which the optical SW is operating is monitored.

The embodiments of the present invention are described below by referring to the attached drawings. In each drawing, a similar component is assigned the same reference numeral.

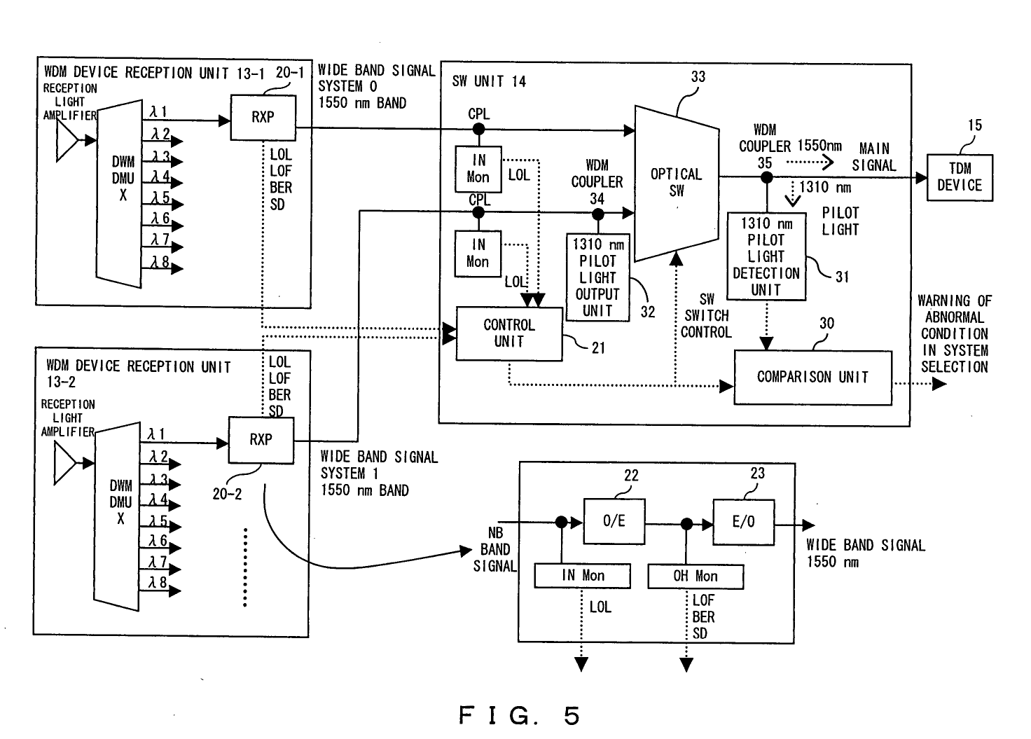

FIG. 5 shows the first embodiment of the present invention.

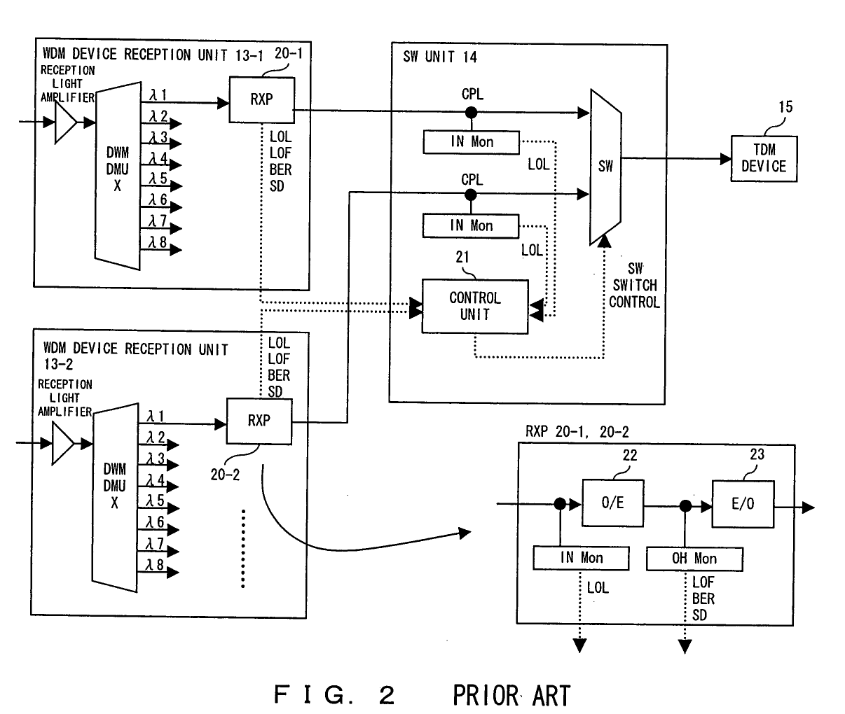

FIG. 5 shows an example of the configuration in which the SW unit 14 comprises an optical signal monitor by the means of the embodiment of the present invention. In addition to the configuration shown in FIG. 2, there are a 1310 nm pilot light output unit 32 for determination of a optical SW selection system, and a WDM coupler 34 for multiplexing an optical signal of 1550 nm band as a main signal on one system of the input side of an optical SW 33. On the output side of the optical SW 33, there are a WDM coupler 35 for demultiplexing the 1550 nm band optical signal of the main signal from the 1310 nm pilot light for determination of an optical SW selection system, and a 1310 nm pilot light detection unit 31 for detection of the demultiplexed 1310 nm pilot light. A comparison unit 30 compares the detection result of the 1310 nm pilot light detection unit 31 with the result of the LOL transmitted from the control unit 21, and determines the system actually operating.

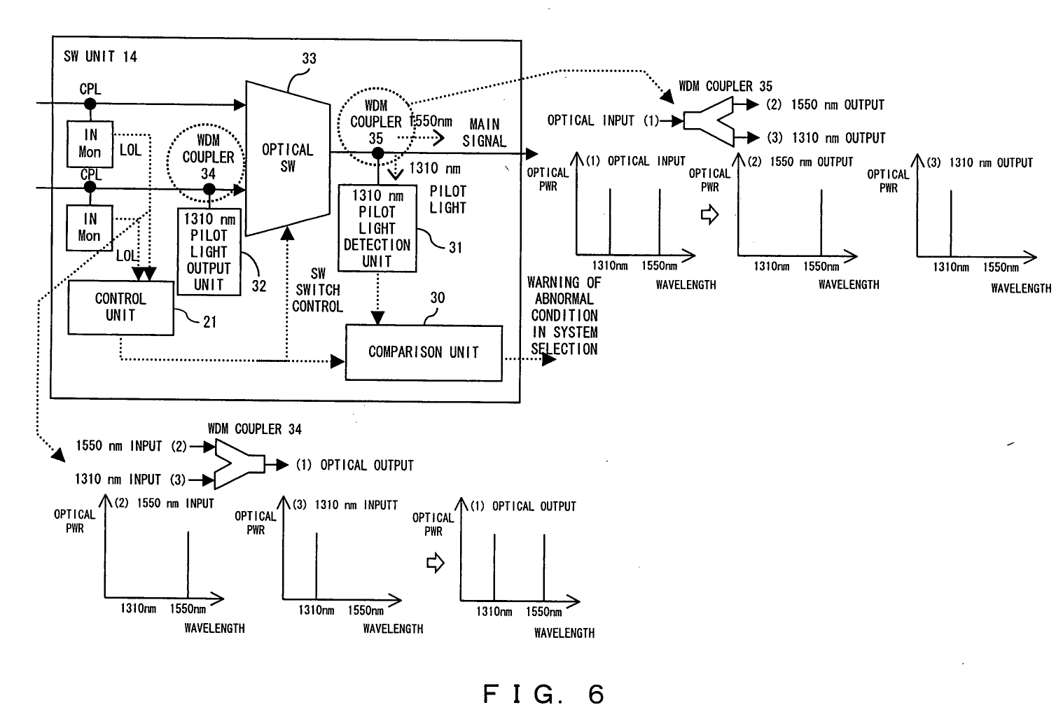

FIG. 6 is an explanatory view showing the characteristic of the WDM coupler 35 shown in FIG. 5.

The characteristics of the WDM coupler 35 connected to the output terminal of the optical SW 33 are set as shown in FIG. 6.

The WDM coupler 34 connected to the input terminal of the optical SW 33 couples the 1550 nm optical signal as a main signal with the 1310 nm optical signal as a pilot light, and transmits the result to the optical SW 33. The WDM coupler 35 connected to the output terminal of the optical SW 33 demultiplexes the 1550 nm band main signal which has passed the optical SW 33 from the 1310 nm pilot light, transmits the 1550 nm main signal to the TDM device 15 connected to a device, and transmits the 1310 nm pilot light to the 1310 nm pilot light detection unit 31.

In an example of the system in the present embodiment, a 1550 nm band main signal and a 1310 nm pilot light are used. However, a main signal of any wavelength band can be monitored by changing the pilot light depending on the wavelength band of the main signal. For example, by using a 980 nm band pilot light for a 1310 nm main signal, system selection can be similarly monitored.

For example, when the system 0 is selected as a device, and the SW is normally operated, a 1310 nm pilot light does not pass through the optical SW 33, and the pilot light cannot be detected by the 1310 nm pilot light detection unit 31. As a result, it is determined that the optical SW 33 normally selects the system 0.

On the other hand, if the SW abnormally works and the optical signal of the system 1 is output even though the system 0 is selected as a device, then the 1310 nm pilot light passes through the optical SW 33. As a result, the 1310 nm pilot light detection unit 31 detects the pilot light, thereby determining that the system 1 has been mistakenly selected due to the abnormal operation of the optical SW 33.

If the system 1 is selected as a device and the optical SW 33 normally operates, the 1310 nm pilot light passes through the optical SW 33 and is detected by the 1310 nm pilot light detection unit 31. When the optical SW 33 abnormally operates and has selected the system 0, the 1310 nm pilot light detection unit 31 does not detect pilot light, thereby determining the abnormal operation of the optical SW 33.

The above-mentioned determination is made by the comparison unit 30 shown in FIG. 5. When an abnormal condition is detected, a warning is issued to the operator, and when the signal is correctly passed, an abnormal condition of the system can be detected before transfer of a fault.

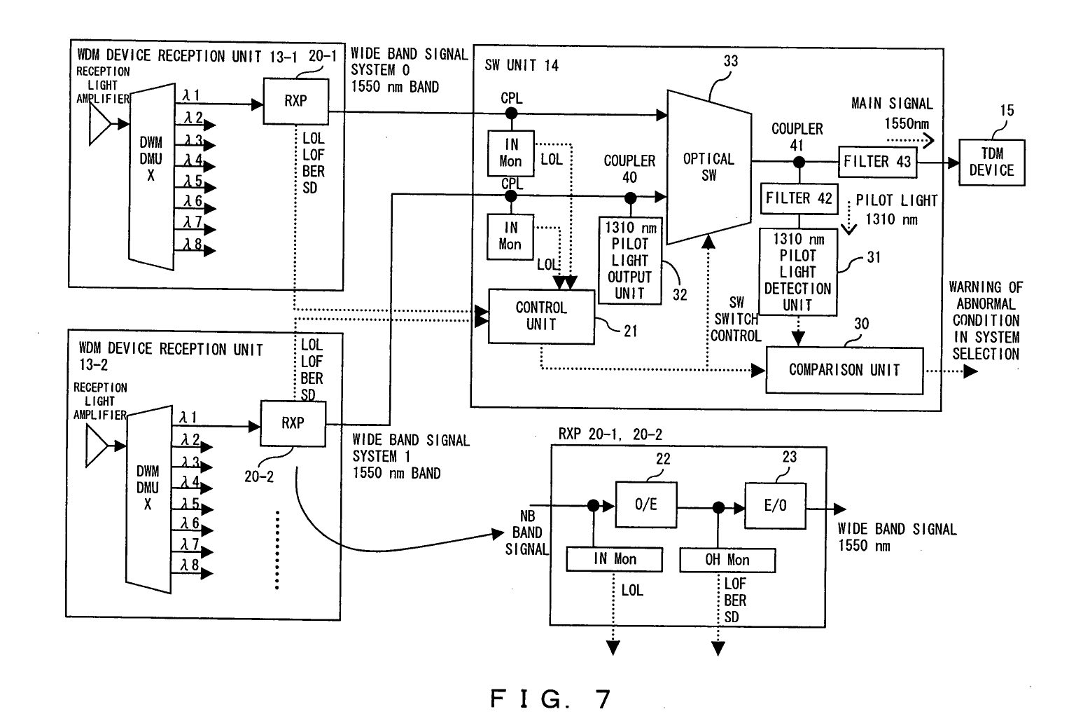

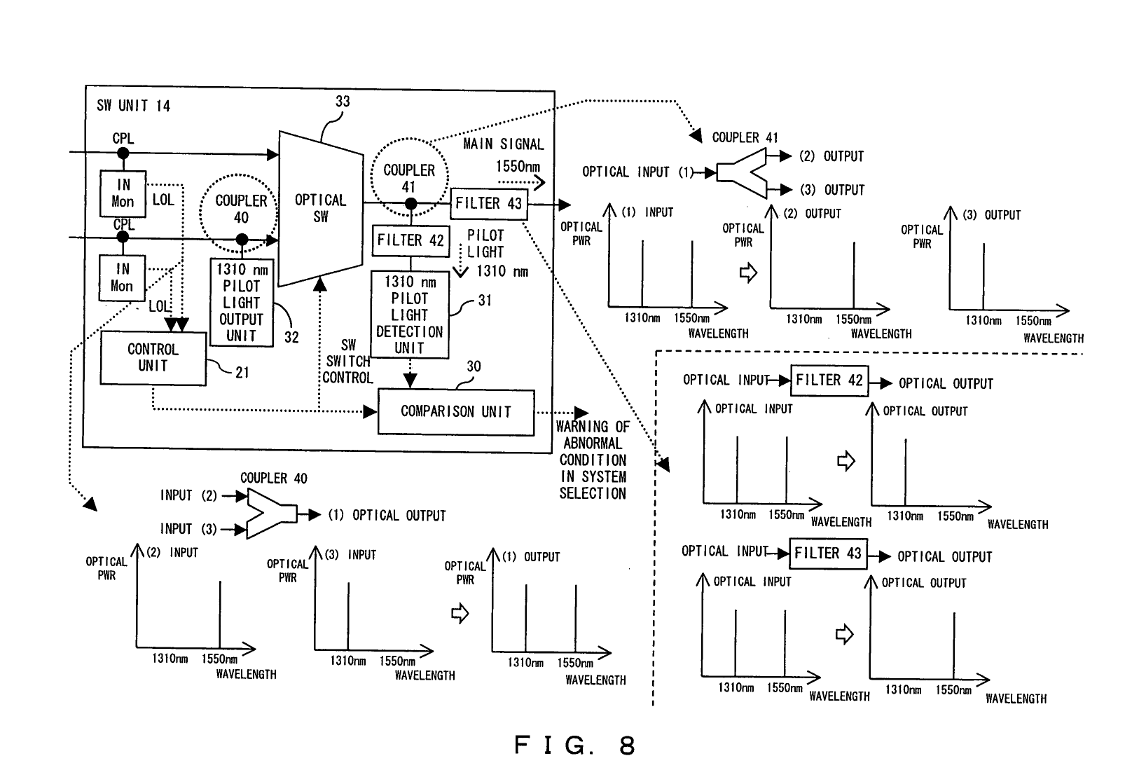

FIGS. 7 and 8 are explanatory views showing the second embodiment of the present invention.

In the second embodiment of the present invention, the optical signals of the 1310 nm band and the 1550 nm band are multiplexed by a normal 2 branch optical coupler, which is realized by the WDM coupler in the first embodiment, and the demultiplexing process is performed by the 2 branch coupler and wavelength differentiating filter. A coupler 41 and a filter 43 have the characteristics as shown in FIG. 8. That is, the filter 43 is configured such that only the main signal can be extracted from the optical signal containing the pilot light branched by the coupler 41. The coupler 41 simply branches into two optical signals which is obtained by coupling the 1310 nm optical signal with the 1550 nm optical signal and passing through the optical SW 33. The filter 42 is a low pass filter which suppresses the light of the 1550 nm band and passes the light of the 1310 nm band, and the filter 43 is a high pass filter which suppresses the light of the 1310 nm band and passes the light of the 1550 nm band.

According to the embodiments of the present invention, the abnormal conditions of the optical SW unit or the optical paths in the process can be detected without an influence on the main signal during the operation. Furthermore, a signal disconnection due to an incorrect system switch can be avoided. When a device recognized system does not match an actually selected system, a signal disconnection due to an inoperable automatic system switch can be avoided.

In the above-mentioned embodiments of the present invention, only pilot light inserted into an optical signal of a background system is described, but the pilot light can also be inserted into the foreground system.

1. An optical protection apparatus which enables correct communications even though there occurs a fault by switching between an optical signal of a foreground system and a background system, comprising:
a switch unit receiving an optical signal of a foreground system and an optical signal of a background system, and selecting the optical signal of the foreground system or the optical signal of the background system;
a pilot signal multiplexing unit multiplexing a pilot light having a wavelength different from wavelengths of the optical signal of the foreground system and the optical signal of the background system with the optical signal of the foreground system or the optical signal of the background system on an input side of said switch unit; and
a pilot light detection unit detecting whether or not a pilot light is contained in the optical signal output by said switch unit on an output side of said switch unit.

2. The apparatus according to claim 1, wherein
said pilot light detection unit comprises:
a WDM coupler unit branching only light of a wavelength of the pilot light from output of said switch unit; and
a unit detecting branched light.

3. The apparatus according to claim 1, wherein
said pilot light detection unit comprises:
a coupler unit branching into two the output light from said switch unit;
a pilot light filter unit extracting only light of a wavelength of the pilot light from one optical signal from the branched output light; and
a unit detecting the extracted light.

4. The apparatus according to claim 3, wherein
said pilot light unit further comprises a main signal filter unit for inputting the 2-branched output light, and passing optical signals of the foreground system and the background system and cutting off light of a wavelength of a pilot light.

5. The apparatus according to claim 1, wherein
optical signals of the foreground system and the background system are 1550 nm band, the pilot light is 1310 nm band, or the optical signals of the foreground system and the background system are 1310 nm band and the pilot light is 980 nm band.
